(19) United States
(12) Patent Application Publication
(10) Pub. No.: US 2009/0191375 A1
(43) Pub. Date: Jul. 30, 2009

(54) ADHESIVE JOINT SEALED WITH SILICONE

(75) Inventors: Uwe Bankwitz, Steinmaur (CH); Ulli Muller, Geroldswil (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 12/308,709

(22) PCT Filed: Jun. 29, 2007
(86) PCT No.: PCT/EP2007/056602

§ 371 Date: Dec. 30, 2008

(30) Foreign Application Priority Data
Jun. 30, 2006 (EP) 06116466.1

(51) Int. Cl. B32B 3/02; B32B 37/12

(52) U.S. Cl. 428/76; 156/60

(57) ABSTRACT

The invention relates to an adhesive joint, for fixing a metallic fixing to a disc, wherein the fixing and the disc are glued by means of a (meth)acrylate adhesive completely enclosed by a silicone sealant.

### FIELD OF THE INVENTION

The present invention relates to the field of adhesive bonding of sheets. The invention concerns an adhesively bonded assembly for fixing a metallic mount to a sheet, the mount and the sheet being bonded to one another via a (meth)acrylate adhesive which is fully encased by a silicone sealant.

### BACKGROUND ART

Metallic mounts for fixing sheets, especially sheets of glass, to components, such as to façades, are known. For example, clamp mountings are used, into which the sheet is fixed in bracketlike manner. A disadvantage is that, for reasons of aesthetics, external components are unwanted, and that, owing to the mechanical nature of fixing, there is a great risk of the incidence of glass fracture. Alternatively, single-point mounts are also used, the sheet being drilled and the corresponding single-point mounting being screwed mechanically to the sheet. Particularly in systems with drilled insulating glass it is necessary to seal off hermetically the drill holes within the spaced glass sheets from the closed interspace surrounding them. The connection is therefore one which is very expensive and very critical in terms of long-term stability.

All mechanically fixed systems harbor the risk of glass fracture, are very costly and inconvenient to produce, and are therefore expensive.

If need be, additionally to the clamp mounting or to the system of drilled glass, the mounts can be bonded to the sheet.

DE 199 39 172 A1 describes a single-point mounting which by means of an adhesive is attached force and form-fittingly to a sheet of insulating glass. To allow the weight of the sheet of insulating glass to be accommodated reliably by the single-point mount through the two spaced sheets as well, however, there is a spacer in the air interspace between the spaced glass sheets. The position of the spacers between the two sheets determines the positions of the single-point mountings to be attached to the sheet.

In the case of adhered single-point mountings there are presently two technologies usually employed on account of their UV stability: silicone sealants, and acrylate adhesives. Silicone sealants are known for their weathering, UV, and temperature resistance and have therefore been used successfully for many years for the bonding of glass in construction. The disadvantage of the silicone sealants is their mechanical strength, which is lower than that of other adhesives. In the case of the bonding of single-point mountings, this results in a need often to make the bond areas, i.e., the size of the single-point mountings, of such a size, in order to bear all of the loads, that it is neither economically nor aesthetically rational. Acrylate adhesives have a higher strength than silicone sealants and are therefore better suited to accommodating even high loads. Their weathering resistance, however, is inadequate, and so they cannot be used, particularly in façade construction, in view of the presently expected long period of use of the building.

### SUMMARY OF THE INVENTION

It is an object of the present invention, therefore, to provide an adhesively bonded mount which overcomes the disadvantages of the prior art. Surprisingly it has been found that an adhesively bonded assembly according to claim 1 achieves this object.

Adhesively bonded assemblies of this kind feature high strength and very good weathering resistance. Surprisingly it has been found that this effect can be achieved through the use of a specific combination of acrylate adhesives and silicone sealants.

### BRIEF DESCRIPTION OF THE DRAWINGS

In the text below, with reference to the drawings, exemplary embodiments of the invention are illustrated in more detail. Like elements in the various figures are given the same reference symbols.

FIG. 1 shows a partial longitudinal section through the adhesively bonded assembly;

FIG. 2 shows a cross section through the bond.

Only the elements essential to the direct understanding of the invention have been shown. Not depicted, for example, is the fixing of the metallic mount to a load-bearing construction.

### DESCRIPTION OF THE PREFERRED EMBODIMENT

The present invention relates to an adhesively bonded assembly comprising a metallic mount, a sheet, and an adhesive arrangement, the adhesive arrangement comprising a (meth)acrylate adhesive which is fully encased by a silicone sealant. The present invention accordingly relates to an adhesively bonded assembly comprising a metallic mount and a sheet, characterized in that the mount and the sheet are bonded to one another via a (meth)acrylate adhesive, the (meth)acrylate adhesive being fully encased by a silicone sealant. Preferably the silicone sealant is disposed between the metallic mount and the sheet. It may alternatively be wholly or at least partly disposed outside the metallic mount. It is essential that the silicone sealant fully encases the (meth)acrylate adhesive. This allows the (meth)acrylate adhesive not to come into contact with the surrounding air and not to be exposed to weathering. The arrangement of the adhesive in the adhesively bonded assembly allows the adhesion of the (meth)acrylate adhesive to be resistant to surrounding influences, particularly to moisture.

By “fully encase” is meant throughout the present document that the silicone sealant seals the (meth)acrylate adhesive, which is disposed between the sheet and the metallic mount, against the surroundings, so that the (meth)acrylate adhesive does not come into contact with surrounding influences, such as atmospheric moisture, for example. In other words, the (meth)acrylate adhesive is in direct contact on the one hand with the sheet and the metallic mount, and on the other hand, at the locations at which the (meth)acrylate adhesive is contacting neither the sheet nor the metallic mount, is in contact with the silicone sealant. Between the sheet and the (meth)acrylate adhesive and also between the metallic mount and the (meth)acrylate adhesive there is, at least in regions, no silicone sealant.

In one embodiment the silicone sealant is in direct contact with the (meth)acrylate adhesive. In another embodiment the silicone sealant does not touch the (meth)acrylate adhesive, there being instead a distance between the silicone sealant and the (meth)acrylate adhesive. The distance may be filled up with air, for example. Preferably the silicone sealant is in direct contact with the (meth)acrylate adhesive.

By “metallic mount” is meant throughout the present document a mount which is suitable for fixing a plate, preferably a sheet, to a load-bearing construction, as for example to a façade, the metallic mount being bonded to the sheet surface. The metallic mount preferably has a planar surface, i.e., a flat or curved surface, which serves as an assembly surface, and which by means of an adhesive can be attached form and force-fittingly to a sheet. The assembly surface preferably has the same surface shape as the sheet to which the metallic mount is bonded. In the contact region to the sheet, the metallic mount may be single-point, oval or angular, especially rectangular or triangular, quadrangular or pentangular, or trapezoidal, or may have a different shape, suitable for bonding between the metallic mount and a sheet. Not considered as a “metallic mount” in the sense of the present invention is a frame, such as a window frame or doorframe, for example, which at least partly surrounds a sheet, particularly a sheet of insulating glass, at its end face.

The metallic mount is preferably a single-point mount. As a connection between the single-point mount and the load-bearing construction it is possible to employ the systems that are commonly used in glass construction, examples being single-point mountings from the company Dorma. Preferred metals for the metallic mount are in particular the metals, and alloys of, iron, aluminum, copper, chromium, and nickel. Steel and aluminum and its alloys are particularly preferred. Particular preference is given to stainless steel.

The cross section through the adhesive and sealant arrangement parallel to the sheet surface preferably has the same shape as the cross section through the surface of the metallic mount. In the case of a single-point mount, the cross section of the adhesive and sealant parallel to the sheet surface is preferably substantially circular. In this embodiment the silicone sealant, which fully encases the (meth)acrylate adhesive, forms a ring around the (meth)acrylate adhesive. The silicone sealant is arranged preferably in a thickness, i.e., a width, of between 0.1 and 20 mm, preferably between 0.2 and 10 mm, more preferably between 0.5 and 2 mm, around the (meth)acrylate adhesive.

The surface of the metallic mount is preferably arranged coplanarly to the surface of the sheet, i.e., the distance between the metallic mount and the sheet is substantially the same all round. The distance between the metallic mount and the sheet, and hence also the thickness of the adhesive arrangement, is preferably less than 1 cm, more preferably between 0.1 and 0.6 cm. The surface of the metallic mount on the side of the adhesive bond, i.e., the assembly surface, preferably has a diameter of 1 to 25 cm, more preferably of 2 to 15 cm, more preferably still of 5 to 10 cm, and the surface area is preferably between 0.5 and 2000 cm², more preferably between 10 and 1000 cm², more preferably still between 50 and 100 cm².

A sheet which is to be fixed to a load-bearing construction may comprise a plurality of adhesively bonded assemblies of the invention. At least one metallic mount is bonded to a sheet. Preferably more than one, in particular more than two, more preferably more than three, most preferably four or more than four, metallic mounts are bonded to a single sheet via the adhesive arrangement of the invention. The greater the number of metallic mounts that are bonded to a single sheet, the smaller may be the respective diameter chosen for the assembly surface of the metallic mount.

It is a particular advantage of the present invention that, with the adhesively bonded assembly of the invention, it is possible to use smaller metallic mounts than in the case of conventional bonds, since the adhesively bonded assembly of the invention is better able to transfer the holding forces, i.e., the loads to be borne, which originate, for example, from the weight of the sheet or from wind suction, to the sheet, and, therefore, minimum sizes of the metallic mounts are sufficient.

By “sheet” throughout the present document is meant a flat or curved plate of glass or a substantially transparent plastic. The plates in question may be single-ply or multi-ply plates, including more particularly sheets with films between the glass plates, of the kind employed as safety glass panes in automotive construction, for the windshield, for example, or sheets with a ceramic coating, preferably glass sheets with a ceramic coating. Preference is given to sheets of multi-ply plates such as insulating glass sheets, especially double and multiple insulating glass sheets, of the kind usual in the construction of windows and doors. The sheet is preferably made of glass.

By a “(meth)acrylate adhesive” is meant, here and throughout the present document, an adhesive which in the uncured state comprises at least one organic (meth)acrylate. By an “organic (meth)acrylate” is meant a monomer or oligomer which contains at least one ester group of acrylic acid or methacrylic acid and hence has at least one polymerizable double bond.

Suitable organic (meth)acrylates are the (meth)acrylate monomers or oligomers that are known to the person skilled in the art. The (meth)acrylate monomers contain in particular one, two or three (meth)acrylate groups. Suitable more particularly are (meth)acrylates of the formula (I) or (II)

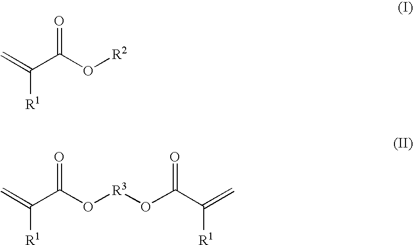

where R¹ is H or CH₃ and where R² is a branched or unbranched organic radical which in particular contains 1 to 30, preferably 4 to 10, carbon atoms and which preferably contains at least one heteroatom, more particularly at least one O. R² may contain cyclic fractions of saturated, unsaturated or aromatic type.

Examples of (meth)acrylate monomers of the formula (I) include hydroxyethyl (meth)acrylate, hydroxypropyl (meth)acrylate, hydroxybutyl (meth)acrylate, methyl (meth)acrylate, ethyl (meth)acrylate, 2-ethylhexyl (meth)acrylate, 2-phenoxyethyl (meth)acrylate, lauryl (meth)acrylate, stearyl (meth)acrylate, cyclohexyl (meth)acrylate, trimethylcyclohexyl (meth)acrylate, tert-butyl (meth)acrylate, dicyclopentadienyl (meth)acrylate, dihydrodicyclopentadienyl acrylate, benzyl (meth)acrylate, isobornyl (meth)acrylate, polypropylene glycol mono(meth)acrylate, polyethylene glycol mono(meth)acrylate, tetrahydrofurfuryl (meth)acrylate, alkoxylated tetrahydrofurfuryl (meth)acrylate or alkoxylated phenol (meth)acrylate or lauryl (meth)acrylate.

R³ in formula (II) is a divalent organic radical which in particular has 2 to 100 C atoms, and preferably has at least one heteroatom, more particularly at least one O. R³ may contain cyclic fractions of saturated, unsaturated or aromatic type.

Examples of (meth)acrylate monomers of the formula (II) include ethylene glycol di(meth)acrylate, propylene glycol di(meth)acrylate, butylene glycol di(meth)-acrylate, 1,6-hexanediol di(meth)acrylate, neopentyl glycol di(meth)acrylate, bisphenol A di(meth)acrylate, polyethylene glycol di(meth)acrylate, polypropylene glycol di(meth)acrylate, and ethoxylated bisphenol A di(meth)acrylate.

Also suitable in principle for use are higher poly-functional (meth)acrylate monomers, such as trimethylolpropane tri(meth)acrylate, pentaerythritol tri(meth)acrylate, for example. In these cases, however, it is preferred for there to be at least one monofunctional or one difunctional (meth)acrylate monomer present.

Having proven particularly suitable as an organic (meth)acrylate are methyl (meth)acrylate or tetra-hydrofurfuryl (meth)acrylate and also blends thereof with other (meth)acrylates. Particularly preference is given to tetrahydrofurfuryl methacrylate or methyl methacrylate.

In one embodiment of the invention the composition of the invention comprises at least two (meth)acrylate monomers of the formula (I) and/or formula (II). Preferably at least one of them is tetrahydrofurfuryl methacrylate or tetrahydrofurfuryl acrylate or methyl (meth)acrylate.

(Meth)acrylate oligomers are in particular oligomers obtained by partial polymerization of the monomers that are suitable as a (meth)acrylate monomer. These oligomers must, however, still contain at least one (meth)acrylate group.

The weight total of all the organic (meth)acrylates is in particular more than 30% by weight, preferably between 40% and 90% by weight, based on the (meth)acrylate adhesive.

The (meth)acrylate adhesive may if desired include further constituents.

Such additional constituents are core-shell polymers, liquid rubbers, catalysts, organic and inorganic fillers, dyes, pigments, inhibitors, UV stabilizers, heat stabilizers, antistats, flame retardants, biocides, plasticizers, waxes, flow control agents, adhesion promoters, thixotropic agents, and other common additives and raw materials known to the person skilled in the art.

Suitable catalysts are on the one hand, in particular, tertiary amines such as, for example, N,N-dimethylaniline, N,N-dimethyl-p-toluidine, N,N-di-ethylaniline, N,N-diethyltoluidine, N,N-bis(2-hydroxyethyl)-p-toluidine, N-ethoxylated p-toluidines, N-alkylmorpholines or mixtures thereof. On the other hand, suitability is possessed by transition metal salts or transition metal complexes, especially those of the metals cobalt, manganese, vanadium, and copper, as catalysts.

Suitable adhesion promoters include, in particular, alkoxysilanes, (meth)acrylates containing phosphorous atoms, or metal (meth)acrylates.

Suitable polymerization inhibitors are, in particular, hydroquinones, especially hydroquinone and methyl-hydroquinones, or t-butyl-p-cresol.

Particularly suitable additional constituents are, besides catalysts, especially core-shell polymers and liquid rubbers.

Core-shell polymers are composed of an elastic core polymer and a rigid shell polymer. Particularly suitable core-shell polymers are composed of a core of crosslinked elastic acrylate polymer or butadiene polymer surrounded on a rigid shell of a rigid thermoplastic polymer.

Particularly suitable core-shell polymers are those which swell, but do not dissolve, in the organic (meth)acrylate.

Preferred core-shell polymers are those known as MBS polymers, which are available commercially under the trade name Clearstrength™ from Atofina or Paraloid™ from Rohm and Haas. The core-shell polymers are used preferably in an amount of 5% to 40% by weight, based on the composition.

Suitable liquid rubbers are, in particular, butadiene/acrylonitrile copolymer-based liquid rubbers or polyurethane-based liquid rubbers. The liquid rubbers preferably have unsaturated double bonds.

Particularly suitable liquid rubbers are on the one hand vinyl-terminated butadiene/acrylonitrile copolymers, of the kind offered commercially as part of the Hycar® VTBNX product series by BFGoodrich®, or by Noveon.

Other liquid rubbers considered particularly suitable are (meth)acrylate-terminated polyurethane polymers. Polymers of this kind can be prepared from polyols and polyisocyanates, with formation of isocyanate-functional polyurethane prepolymers, which are subsequently reacted with hydroxyalkyl (meth)acrylates. Preferred isocyanate-functional polyurethane prepolymers are the reaction product of a polyisocyanate, in particular a diisocyanate, and a polyol, in a ratio of isocyanate group equivalents to hydroxyl group equivalents of greater than 1. Accordingly adducts of NCO-xx-NHCO—O-yy-O—OCONH-xx-OCN type are also considered polyurethane prepolymers in this context, where xx is a diisocyanate without NCO groups and yy is a diol without OH groups.

For this purpose it is possible in principle to use any polyol HO—R—(OH)_{q} with q≧1, R being a polymer backbone with heteroatoms in the backbone or as side chains. Preferred polyols are polyols selected from the group consisting of polyoxyalkylene polyols, also called “polyether polyols”, polyester polyols, polycarbonate polyols, and mixtures thereof. Preferred polyols are diols. The most preferred diols are polyoxyethylene diols or polyoxypropylene diols or polyoxybutylene diols.

The polyoxyalkylene polyols may have a low degree of unsaturation (measured in accordance with ASTM D-2849-69 and expressed in milliequivalents of unsaturation per gram of polyol (meq/g)), prepared for example by means of what are called double metal cyanide complex catalysts (DMC catalysts), or else may have a higher degree of unsaturation, being prepared, for example, by means of anionic catalysts such as NaOH, KOH, CsOH or alkali metal alkoxides.

The use of polyoxyalkylene polyols with a low degree of unsaturation, especially one of less than 0.01 meq/g, is preferred for polyols having a molecular weight of ≧2000.

In principle it is possible to use any polyisocyanates having two or more isocyanate groups.

Mention may be made, by way of example, of 2,4- and 2,6-tolylene diisocyanate (TDI) and mixtures thereof, 4,4′-diphenylmethane diisocyanate (MDI), any isomers of diphenylmethane diisocyanate, 1,3- and 1,4-phenylene diisocyanate, 2,3,5,6-tetramethyl-1,4-diisocyanato-benzene, 1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,12-dodecamethylene diisocyanate, cyclohexane 1,3- and 1,4-diisocyanate and any mixtures of these isomers with one another, 1-isocyanato-3,3,5-trimethyl-5-isocyanatomethylcyclohexane (viz. isophorone diisocyanate or IPDI), perhydro-2,4′- and -4,4′-diphenylmethane diisocyanate (HMDI), 1,4-diisocyanato-2,2,6-trimethylcyclohexane (TMCDI), m- and p-xylylene diisocyanate (XDI), 1,3- and 1,4-tetramethylxylylene diisocyanate (TMXDI), 1,3- and 1,4-bis(isocyanatomethyl)cyclohexane, any oligomers or polymers of the abovementioned isocyanates, and also any mixtures of the stated isocyanates with one another. Preferred polyisocyanates are MDI, TDI, HDI, IPDI, and their mixtures with one another. Most preferred are IPDI and HDI and a mixture thereof.

The isocyanate-terminated prepolymers prepared from the polyols and polyisocyanates are reacted with (meth)acrylic esters which contain hydroxyl groups. Preferred (meth)acrylic esters which contain hydroxyl groups are hydroxyethyl (meth)acrylate or hydroxypropyl (meth)acrylate. The two reactants are reacted with one another in a manner known per se, typically in a stoichiometric excess of the (meth)acrylic ester which contains hydroxyl groups.

The preferred (meth)acrylate-terminated polyurethane polymer is the reaction product of an IPDI/polypropylene glycol polyurethane prepolymer or of an HDI/polypropylene glycol polyurethane prepolymer with hydroxyethyl (meth)acrylate or with hydroxypropyl (meth)acrylate.

The polyurethane prepolymer and/or the (meth)acrylate-terminated polyurethane polymer can be prepared in the presence of the organic (meth)acrylate, provided the latter contains no NCO-reactive groups.

The liquid rubbers are used preferably in an amount of 5% to 40% by weight, based on the (meth)acrylate adhesive.

The (meth)acrylate adhesive can be prepared in principle with the apparatus and processes known to the person skilled in the art. In particular, however, the following preparation process has proven advantageous:

The organic (meth)acrylate is placed in a reaction vessel. Subsequently the liquid rubber and/or core-shell polymer present if appropriate is/are incorporated with stirring. Finally, further raw materials such as activators, adhesion promoters, additives, etc. are incorporated with stirring. When a homogeneous composition has been obtained, it is deaerated if necessary and packed.

The (meth)acrylate adhesive can be cured thermally, by radiation or by chemical generation of free radicals.

In one preferred embodiment curing is accomplished by chemical generation of free radicals. In that case the (meth)acrylate adhesive is a free-radically curing two-component (meth)acrylate adhesive composed of a first component K1 and a second component K2. To this end the raw materials used are distributed between the two components in such a way as to ensure adequate storage stability. One preferred two-component (meth)acrylate adhesive of this kind is described as follows:

The first component K1 forms the above-described (meth)acrylate adhesive.

The second component K2 contains a free-radical initiator. This free-radical initiator is in particular a peroxide or a perester. Peroxides include not only hydrogen peroxide but especially organic peroxides or hydroperoxides.

The organic peroxides or hydroperoxides that can be used are guided by the fields of use, temperatures, and the chemical compatibility with other raw materials. A peroxide which has proven particularly preferred is dibenzoyl peroxide. Preferred hydroperoxides are cumene hydroperoxide and isopropyl cumene hydroperoxide in particular.

A preferred free-radical initiator is dibenzoyl peroxide.

Component K2 may comprise further constituents. These are, in particular, the additional constituents specified above in connection with the (meth)acrylate adhesive that acts as component K1, subject to the condition that these additional constituents do not react with other ingredients, such as the free-radical initiator, for example, to any notable extent, at least during the storage time.

Components K1 and K2 preferably possess comparable viscosities.

The volume ratio of component K1 to K2 is preferably between 20:1 and 1:2, preferably about 10:1. Components K1 and K2 are mixed for curing. The resulting mixture is preferably pastelike and more preferably thixotropic. Prior to mixing, components K1 and K2 are stored in separate containers.

A (meth)acrylate adhesive which cures by radiation is suitable. Curing is accomplished in particular by UV radiation, using a UV lamp.

By a “silicone sealant”, here and throughout the present document, is meant a sealant which comprises at least one polydiorganosiloxane and at least one crosslinking agent. Sealants of this kind are also referred to as silicone rubbers, which as base polymers comprise polydiorganosiloxanes which contain at least two reactive groups. Suitable reactive groups are preferably H, OH, alkoxy or vinyl groups, which preferably are located at the chain ends but may also be incorporated in the chain.

Particular preference is given to room temperature vulcanizing (RTV) silicone rubbers. Both one-component (RTV-1) and two-component (RTV-2) systems are suitable. In the case of RTV-1 systems the room temperature crosslinking rubbers are composed of one component, i.e., the crosslinker is present in the rubber and becomes active even in response to atmospheric moisture. In the case of RTV-2 systems the room temperature crosslinking rubbers are composed of two components; crosslinking begins only when the two components are mixed together. As a crosslinker component in the case of two-component rubbers use is made, for example, of mixtures of silicic esters (e.g., ethyl silicate) and organotin compounds.

The one-component system (RTV-1) has emerged as being particularly preferred, the silicone sealant polymerizing at room temperature under the influence of moisture, especially of atmospheric moisture, and crosslinking taking place by condensation of SiOH groups to form Si—O—Si bonds.

Suitable crosslinkers or crosslinking agents are polyfunctional organosilicon compounds which are able to react at room temperature with OH groups, such as silanol groups of the polymers or the OH groups of water, for example. Polyfunctional means that at least three reactive groups are present in the crosslinker molecule. Depending on the crosslinking agent used, the curing of the RTV-1 rubbers may take place acidically, in the presence for example of carboxysilanes, basically, by means for example of aminosilanes, or neutrally, for example through compounds containing oximo or alkoxy groups. As a crosslinking agent it is preferred to use at least one carboxysilane, at least one oximosilane, or at least one alkoxysilane.

Neutrally crosslinking silicone sealants which contain at least one ketoximosilane or at least one alkoxysilane have emerged as being particularly suitable. Neutrally crosslinking silicone sealants which release a neutral cleavage product on crosslinking are used in particular when reaction or incompatibility with the substrate is to be avoided.

A suitable crosslinker is preferably an organosilane and/or its partial hydrolyzate of the general formula (III)

R⁴ₓSi(OR⁵)₄₋ₓ (III)

where R⁴ independently at each occurrence is H or unsubstituted or substituted alkyl and/or alkenyl and/or aryl radicals, preferably methyl, and where R⁵ independently at each occurrence is H and/or unsubstituted and/or substituted alkyl, acyl, and/or silyl radicals, and
where x is either 0 or 1.

The substituents R⁴ and R⁵ may contain homoatoms or heteroatoms such as N or O, for example. Examples of suitable substituents are epoxy, amines, esters or oximes, preferably amines or oximes.

More preferably the organosilane is an alkoxysilane, an acetoxysilane, an aminosilane, a carboxysilane or an oximosilane, especially an alkoxysilane or a ketoximosilane.

Particularly suitable alkoxysilanes are methoxysilanes or ethoxysilanes. It is possible by way of example to use the following compounds: methyltrimethoxysilane, methyltriethoxysilane, vinyltriethoxysilane, tetra-ethoxysilane, phenyltriethoxysilane, tetrakis(2-methoxyethoxy)silane, tetrakis(2-butoxyethoxy)silane, N-1-(triethoxysilyl)ethylpyrrolid-2-one, N-2-(tri-ethoxysilyl)ethylpyrrolid-2-one, N-1-(triethoxysilyl)-ethyl-N-methylacetamide, N-2-(triethoxysilyl)ethyl-N-methylacetamide, N-1-(triethoxysilyl)ethylsuccinimide, N-2-(triethoxysilyl)ethylsuccinimide, N-1-(triethoxysilyl)ethylphthalimide, N2-(triethoxysilyl)ethyl-phthalimide, N-1-(tris(2-methoxyethoxy)silyl)ethyl-N-methylthioacetamide, N-2-(tris(2-methoxyethoxy)silyl)-ethyl-N-methylthioacetamide, or mixtures of the N-1- and N2-(triethoxysilyl)ethylamides. It is also possible to use any desired mixtures of the aforementioned compounds.

Suitable oximosilanes are aldoximosilanes or ketoximosilanes, preferably methylisobutylketoximosilanes or methylethylketoximosilanes.

The amount of the organosilane of the general formula (III) to be employed is guided by the amount of silicon-bonded hydroxyl or alkoxy groups in the polydiorganosiloxane of the general formula (IV), and can easily be adapted by the person skilled in the art to the particular conditions. Preferably the alkoxy silane of the general formula (III) is present in amounts between 0.1% and 10% by weight, more preferably 1% to 5% by weight, based on the total weight of the silicone sealant.

The silicone sealants preferably comprise at least one linear polydiorganosiloxane having at least two hydrolyzable end groups. It is preferred to use a hydroxy-terminated polydiorganosiloxane of the general formula (IV)

HO(SiR⁶₂O)ₙH (IV)

where R⁶ independently at each occurrence is unsubstituted or substituted alkyl and/or alkenyl and/or aryl radicals, preferably methyl, and n adopts values from 20 to 3000, preferably values from 100 to 1600.

The polydiorganosiloxanes of the general formula (IV) that are used are known. Customarily they are prepared either by polymerization of cyclic siloxanes in the presence of strongly basic or acidic catalysts and small amounts of water, or by polycondensation of short-chain linear oligomers having OH end groups. Since the starting compounds used for this synthesis may contain not only the primarily desired difunctional units but also trifunctional and tetrafunctional units as well, there are always compounds present in the polymers that contain one or else two or more branches in the molecule. The greater the amount of trifunctional or tetrafunctional units in the starting materials and the greater the molar mass of the polymer, the greater the probability that the molecules will contain branching sites.

The polydiorganosiloxane is preferably an α,ω-dihydroxypolydialkylsiloxane or an α,ω-dialkoxysilylpolydialkylsiloxane. Preferred substituents R⁶ are methyl, ethyl, phenyl, vinyl and trifluoropropyl radicals. Particular preference on account of their ready availability is given to α,ω-dihydro-oxypolydimethylsiloxanes in which n in the formula (IV) adopts values from 100 to 1600. Although the use of purely linear polymers is preferred, it is also possible to use those polymers which contain branching sites. In the silicone sealant of the present invention there are usually 30% to 70% by weight of polydiorganosiloxanes of the general formula (IV).

The silicone sealant may if desired comprise further constituents as well.

Additional constituents of this kind are plasticizers, catalysts, organic and/or inorganic fillers, curing accelerants, pigments, adhesion promoters, processing assistants, dyes, inhibitors, heat stabilizers, antistats, flame retardants, biocides, waxes, flow control agents, thixotropic agents, and other common additives and raw materials known to the person skilled in the art. Besides at least one polydiorganosiloxane and at least one crosslinking agent, the silicone sealant preferably comprises at least one plasticizer, at least one catalyst, and, if desired, at least one filler.

Suitable plasticizers are especially alkyl-terminated polydialkylsiloxanes, more particularly methyl-terminated polydimethylsiloxanes. Preference is given to trimethylsilyl-terminated polydimethylsiloxanes having viscosities of between 0.01 and 10 Pas. Viscosities between 0.1 and 1 Pas are particularly preferred. It is, however, also possible to use methyl-terminated polydimethylsiloxanes in which some of the methyl groups have been replaced by other organic groups such as, for example, phenyl, vinyl or trifluoropropyl. Although linear trimethylsilyl-terminated polydimethylsiloxanes are used with particular preference as plasticizers, it is also possible to use compounds which contain a number of branching sites, which come about by virtue of the fact that there are small amounts of trifunctional or tetrafunctional silanes present in the starting products that serve for preparing the plasticizers. It is, however, also possible to use—instead of the siloxanes—up to 25% by weight, based on the total mixture, of other organic compounds, such as certain aromatic-free hydrocarbon mixtures, for example, as plasticizers.

In order to achieve a sufficiently high crosslinking rate it is preferred to use 0.01% to 5% by weight, based on the total weight of the silicone sealant, of a catalyst. Customary compounds are organotin compounds, preferably dialkyltin compounds, such as dibutyltin dilaurate or diacetate, for example, or titanium compounds, such as tetrabutyl or tetraisopropyl titanate, or titanium chelates. Catalyst mixtures can also be employed.

To achieve particular mechanical properties it is possible to use active or inactive fillers. Preferred fillers with a high specific surface area are fumed silica or precipitated calcium carbonate. It is possible, furthermore, to use fillers having a low specific surface area as extenders. In the case of inactive fillers, chemical or physical interactions with the polymer occur not at all or only to a minor extent. Used in practice are calcium carbonates, aluminum silicates, finely ground quartz, diatomaceous earth, iron oxides, etc. Preference is given here to ground calcium carbonate. In one particularly preferred embodiment the silicone sealant of the adhesively bonded assembly of the invention comprises fumed silica as a filler.

Particularly suitable adhesion promoters are preferably alkoxysilanes substituted by functional groups. The functional group is, for example, an aminopropyl, glycidyloxypropyl or mercaptopropyl group. Amino-functional groups are preferred. The alkoxy group of the silane is usually a methoxy or ethoxy group. Particular preference is given to amino-propyltrimethoxysilane, 3-aminopropyltriethoxysilane, 3-(2-aminoethyl)aminopropyltriethoxysilane, and 3-mercaptopropyltriethoxysilane. It is also possible to use a mixture of alkoxysilanes substituted by functional groups.

Having emerged as being particularly suitable silicone sealants are the silicone rubber mixtures described in EP0885931A2.

The silicone sealant can be prepared continuously or discontinuously in accordance with the methods and apparatus that are known to the person skilled in the art.

In one particularly preferred embodiment the sheet is bonded to the metallic mount via a chemically curing (meth)acrylate adhesive which is encased by a silicone sealant that comprises α,ω-dialkoxypolydimethylsiloxane, an alkoxysilane, trimethylsilyl-terminated polydimethylsiloxane, and dibutyltin diacetate.

In a further aspect the present invention relates to the use of an adhesively bonded assembly of the invention to fix a sheet to a load-bearing construction. The load-bearing construction may be, for example, a façade of a building or a metallic construction which is mounted on a façade. Alternatively the load-bearing construction may be any desired edifice in construction or civil engineering, an industrial product or a part thereof, such as a table leg, for example, or part of a means of transport, such as the body of a vehicle, boat or aircraft, for example.

The adhesively bonded assembly of the invention permits very good adhesion under any weathering conditions. For example, adhesively bonded assemblies may be subject to extreme weathering conditions in the context of the bonding of glass plates to parts of building façades. As a result of the full encasement of the (meth)acrylate adhesive with silicone sealant, the effective adhesion of the (meth)acrylate adhesive on the sheet and also on the metallic mount is maintained, and rain or high atmospheric humidity has virtually no adverse effect on the adhesion.

The invention further relates to a method of fixing a metallic mount to a sheet, comprising the steps of
applying a (meth)acrylate adhesive to the sheet and/or to the metallic mount, and contacting the (meth)acrylate adhesive with the sheet and/or the metallic mount, or applying a (meth)acrylate adhesive between the sheet and the metallic mount;
applying a silicone sealant around the (meth)acrylate adhesive.

The contacting of the (meth)acrylate adhesive with the sheet and/or with the metallic mount takes place within the open time of the adhesive. Preferably the (meth)acrylate adhesive is applied to the sheet and is joined within the open time to the metallic mount. Alternative the sheet and the metallic mount may be brought to the desired distance from one another in advance, as for example with a spacer, and then the (meth)acrylate adhesive can be applied between the sheet and the metallic mount. The spacer may additionally be used so that the (meth)acrylate adhesive can be applied in the desired shape—for example, substantially circularly in the case of a single-point mounting—and also in the desired size. The height of the spacer determines the distance between the sheet and the metallic mount. The spacer is, for example, a ring with an opening through which the (meth)acrylate adhesive is introduced after the metallic mount has been applied to the spacer, which is located between the sheet and the metallic mount. In another embodiment the spacer is first brought to the desired position on the sheet, and filled with (meth)acrylate adhesive, and then the metallic mount is pressed onto the (meth)acrylate adhesive. The opening in the spacer allows the excess (meth)acrylate adhesive in this case to be pressed out. The spacer may be made, for example, of high temperature vulcanizing silicone rubber.

In a further step, after the joining, the adhesive is preferably cured. Application of the silicone sealant around the (meth)acrylate adhesive may take place either immediately after the application of the (meth)acrylate adhesive or, preferably, after the (meth)acrylate adhesive has cured. The person skilled in the art, however, is of course aware that the crosslinking of the adhesive begins immediately after contact with atmospheric moisture or on exposure to UV light. Therefore, the curing term is to be understood not as the beginning of curing, or beginning of crosslinking, but instead to the effect that crosslinking has already advanced to a sufficient extent that the adhesive has already developed a strength sufficient to transmit forces, and has attained what is referred to as early strength. Curing is over when the adhesive has attained its ultimate strength. The silicone sealant may be applied throughout the cure time and after curing is over, around the (meth)acrylate adhesive.

Suitable methods of applying (meth)acrylate adhesive and/or silicone sealant are, for example, application from standard commercial cartridges, which are preferably operated manually. Application by means of compressed air from a standard commercial cartridge or from a drum or hobbock by means of a conveying pump or an extruder, if appropriate by means of an application robot, is likewise possible.

If necessary, the sheet and/or the metallic mount may be pretreated before the adhesive and sealant is applied. Such pretreatments include, in particular, physical and/or chemical cleaning processes, such as abrading, sandblasting, brushing or the like, for example, or treatment with cleaners or solvents; or the application of an adhesion promoter, an adhesion promoter solution or a primer; or flame treatment or plasma treatment, especially an air plasma pretreatment at atmospheric pressure.

After a metallic mount has been fixed to a sheet, an article is obtained which comprises an adhesively bonded assembly of the invention. Such an article may be a built structure, in particular a built structure in construction or civil engineering, or may be an industrial product or a consumer good such as, for example, a window, a household appliance or a means of transport, such as a water or land vehicle, for example, especially an automobile, a bus, a truck, a train or a boat, or a component for installation thereof. Preferably the article is a building or an industrial product or a component for installation thereof.

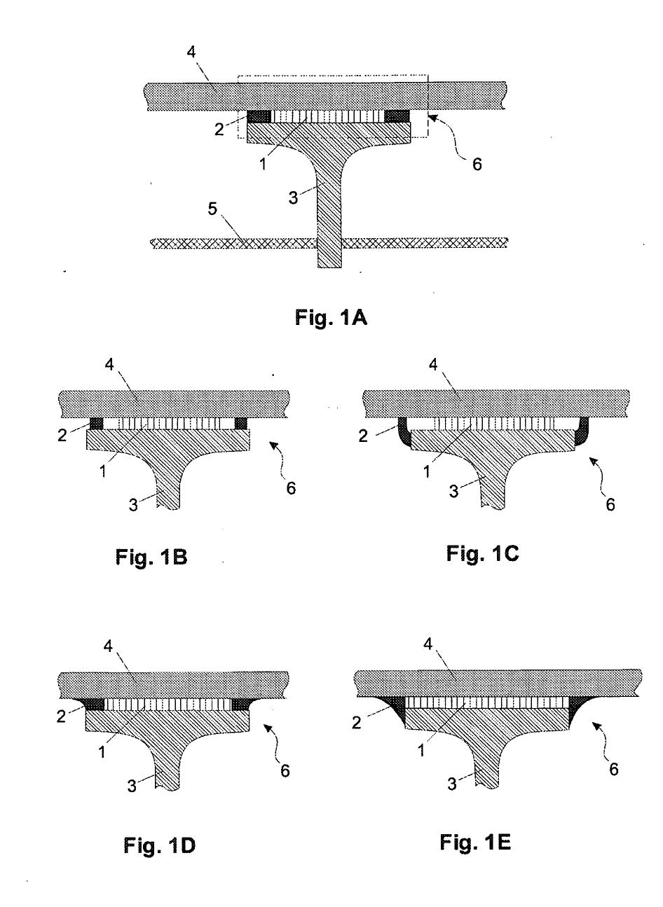

FIG. 1 shows a diagrammatic representation of a partial longitudinal section through the adhesively bonded assembly 6. The metallic mount 3 is bonded via a (meth)acrylate adhesive 1 to the sheet 4. The (meth)acrylate adhesive 1 is fully encased by the silicone sealant 2. The metallic mount 3 is preferably a single-point mounting.

In FIG. 1A the silicone sealant 2 is in direct contact with the (meth)acrylate adhesive 1. The metallic mount 3 is fixed on the side opposite the bond to a load-bearing construction 5. Fixing may take place by a method known to the person skilled in the art. The load-bearing construction is, for example, a façade or an iron frame which is fixed to a façade.

In FIG. 1B the silicone sealant 2 is not in direct contact with the (meth)acrylate adhesive 1; instead, there is a distance between the silicone sealant 2 and the (meth)acrylate adhesive 1.

FIG. 1C shows a further version in which the silicone sealant 2 is not in direct contact with the (meth)acrylate adhesive 1. Again there is a distance between the silicone sealant 2 and the (meth)acrylate adhesive 1. The silicone sealant 2 is located not only between the sheet 4 and the metallic mount 3, but is attached to the outside of the metallic mount 3.

FIGS. 1D and 1E show further embodiments in which the (meth)acrylate adhesive 1 is fully encased by the silicone sealant 2 and hence the (meth)acrylate adhesive 1 is completely sealed from the surrounding air.

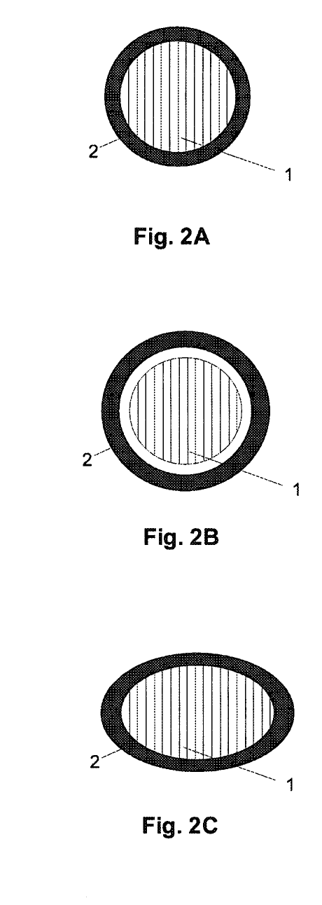

FIG. 2 shows a schematic representation of a cross section through the bond in which the (meth)acrylate adhesive 1 is fully encased by the silicone sealant 2.

In FIG. 2A the silicone sealant 2 is in direct contact with the (meth)acrylate adhesive 1. The cross section has a substantially circular form; the (meth)acrylate adhesive 1 forms a concentric circle around which the silicone sealant 2 has been attached in a ring shape. This form is suitable preferably for metallic single-point mountings.

In FIG. 2B the silicone sealant 2 is not in direct contact with the (meth)acrylate adhesive 1; instead, there is a distance between the silicone sealant 2 and the (meth)acrylate adhesive 1.

In FIG. 2C the silicone sealant 2 is in direct contact with the (meth)acrylate adhesive 1. The cross section has a substantially oval form.

### EXAMPLES

### Description of the Test Methods

To examine the effectiveness of the invention, different bonded specimens were made using float glass and stainless steel substrates. Both substrate surfaces were pretreated with Sika®ADPrep (available from Sika Schweiz AG). The tensile strength was determined on float glass/stainless steel H-piece specimens (in a method based on ISO 8339) with an adhesive layer thickness of 4 mm (bond area 4×50 mm; measurement at 23° C. with a pulling speed of 5 mm/min). In the case of the acrylate bond (Sika®Fast-5211, available from Sika Schweiz AG) encased using the silicone sealant Sikasil® SG-20 (available from Sika Schweiz AG) the bond area of the acrylate was likewise 4×50 mm. The silicone encasement had a thickness of about 0.5 mm, and so the overall bond area was about 5×51 mm.

Some of the specimens were tested after curing (7 days at 23° C./50% relative humidity). The remaining specimens were subjected to artificial ageing. This took place over a period of 14 days in a Suntest XLS from Atlas, at a water temperature of 55° C. and with an irradiation output of 550 watts. This storage is based on the UV/water storage method specified in the guidelines of the European Organization for Technical Approvals (EOTA) for bonded glass constructions, ETAG 002. Table 1 shows that the tensile strength after artificial ageing is significantly increased when the adhesively bonded assembly comprises a (meth)acrylate adhesive which is encased by the silicone sealant, as compared with the adhesively bonded assembly without silicone encasement.

The tensile shear strength was determined in the method based on ISO 4587/DIN EN 1465 on a Zwick/Roell Z005 tensile machine (bonded area: 12 mm×25 mm, layer thickness: 1.5 mm, measuring speed: 10 mm/min; substrates: float glass plaques, measurement temperature: 23° C.). The glass plaques were arranged in the manner described in the standard, to give an adhesive-filled overlap with dimensions of 12 mm width, 25 mm length, and 1.5 mm thickness. In the case of the bond encased using silicone sealant, first SikaFast® 5211 (available commercially from Sika Schweiz AG) was applied to the glass plaques over an area of 12×25 mm, and then Sikasil®SG-20 (available commercially from Sika Schweiz AG) was applied rectangularly around the SikaFast® 5211, forming overall a bond area of 15×28 mm. This corresponds to a rectangular encasement with a thickness of 1.5 mm. Some of the specimens were tested after curing (7 days at 23° C./50% relative humidity). The remaining specimens were subjected to artificial ageing. This took place over a period of 14 days in a Suntest XLS from Atlas, at a water temperature of 55° C. and with an irradiation output of 550 watts. This storage is based on the UV/water storage method specified in the guidelines of the European Organization for Technical Approvals (EOTA) for bonded glass constructions, ETAG 002. The test specimens were then pulled apart to breaking point, with a crosshead speed of 10 mm/min. Table 1 shows that the tensile shear strength after artificial ageing is significantly increased when the adhesively bonded assembly comprises a (meth)acrylate adhesive which is encased by the silicone sealant, as compared with the adhesively bonded assembly without silicone encasement.

TABLE 1
Test results of sample bonding; d = days
Results of the mechanical tests:

| | Adhesive | | | |
|---|---|---|---|---|
| | | | SikaFast ® 5211 | SikaFast ® 5211 |
| | SikaFast ® | SikaFast ® | encased with | encased with |
| | 5211 | 5211 | Sikasil ®SG-20 | Sikasil ®SG-20 |
| Storage | 7 d curing | 14 d Suntest | 7 d curing | 14 d Suntest |
| Tensile | 3.10 | 0.31 | 3.10 | 1.76 |
| strength | | | | |
| [MPa] | | | | |
| Tensile | 4.77 | 1.53 | 5.55 | 4.70 |
| shear | | | | |
| strength | | | | |
| [MPa] | | | | |

The invention is of course not confined to the exemplary embodiment described and shown. It will be understood that the features of the invention that have been specified above can be used not only in the particular combination indicated but also in other modifications, combinations, and adaptations, or alone, without departing the scope of the invention.

### LIST OF REFERENCE SYMBOLS

1 (meth)acrylate adhesive
2 silicone sealant
3 metallic mount
4 sheet
5 load-bearing construction
6 adhesively bonded assembly

1. An adhesively bonded assembly comprising a metallic mount and a sheet, wherein the mount and the sheet are bonded to one another by a (meth)acrylate adhesive, the (meth)acrylate being fully encased by a silicone sealant.

2. The adhesively bonded assembly of claim 1, wherein the silicone sealant is disposed between the metallic mount and the sheet.

3. The adhesively bonded assembly of claim 1, wherein the silicone sealant is in direct contact with the (meth)acrylate adhesive.

4. The adhesively bonded assembly of claim 1, wherein the (meth)acrylate adhesive in the uncured state comprises at least one methyl (meth)acrylate or a tetrahydrofurfuryl (meth)acrylate.

5. The adhesively bonded assembly of claim 1, wherein the (meth)acrylate adhesive cures by chemical generation of free radicals.

6. The adhesively bonded assembly of claim 1, wherein the mount is a single-point mount.

7. The adhesively bonded assembly of claim 1, wherein the mount is made of steel.

8. The adhesively bonded assembly of claim 1, wherein the silicone sealant comprises at least one polydiorganosiloxane and at least one crosslinking agent.

9. The adhesively bonded assembly of claim 8, wherein the polydiorganosiloxane is an a,w dihydroxypolydimethylsiloxane and the crosslinking agent is an alkoxysilane.

10. The adhesively bonded assembly of claim 1, wherein the cross section of the adhesive and sealant parallel to the sheet surface is circular.

11. The adhesively bonded assembly of claim 1, wherein the sheet is made of glass.

12. The adhesively bonded assembly of claim 1, wherein the thickness of the adhesive between the sheet and the metallic mount is less than 1 cm.

13. The method of an adhesively bonded assembly of claim 1 to fix a sheet to a load-bearing constructions.

14. A method of fixing a metallic mount to a sheet, comprising the steps of
a) applying a (meth)acrylate adhesive to the sheet and/or the metallic mount, and contacting the (meth)acrylate adhesive with the sheet and/or the metallic mount, or
a′) applying a (meth)acrylate adhesive between the sheet and the metallic mount, and
b) applying a silicone sealant around the (meth)acrylate adhesive.

15. An article comprising at least one adhesively bonded assembly of claim 1.

16. The article of claim 15, wherein the article is one of a built structure, an industrial product and a means of transport.
